(19) United States
(12) Patent Application Publication
(10) Pub. No.: US 2007/0038831 A1
(43) Pub. Date: Feb. 15, 2007

(54) Memory module and memory system

(76) Inventors: Hong-Kyun Kim, Seongnam-si (KR); Do-Chan Choi, Seoul (KR)

Correspondence Address: MILLS & ONELLO LLP, ELEVEN BEACON STREET, SUITE 605, BOSTON, MA, 02108, US

(21) Appl. No.: 11/416,332

(22) Filed: May 2, 2006

(30) Foreign Application Priority Data
May 3, 2005 (KR) 10-2005-0037180

(51) Int. Cl. G06F 13/00

(52) U.S. Cl. 711/167; 711/154

(57) ABSTRACT

A memory module includes a plurality of semiconductor memory devices, a plurality of module tabs and a memory buffer. The plurality of the semiconductor memory devices stores first data, wherein at least one of the plurality of the semiconductor memory devices has a lower latency. The plurality of the module tabs is used to transfer a signal and data to/from an external device. The memory buffer buffers the first data output from the semiconductor memory devices to the module tabs and buffers second data and a signal provided from an external device through the module tabs to the semiconductor memory devices. Therefore, a latency of a memory module may be reduced.

### CROSS-REFERENCE TO RELATED APPLICATION

This application claims priority under 35 USC §119 to Korean Patent Application No. 2005-37180, filed on May 3, 2005, the contents of which are herein incorporated by reference in its entirety.

### BACKGROUND OF THE INVENTION

1. Field of the Invention

The present invention relates to a memory module and a memory system, and more particularly to a memory module having low latency and a memory system having the same.

2. Description of the Related Art

In a semiconductor memory device, a predetermined period of time is required from an input of a read command to an output of read data. The predetermined period of time is called latency. The latency varies according to the type of semiconductor memory device. Among semiconductor memory devices, some semiconductor memory devices such as a dynamic random access memory (DRAM), a static random access memory (SRAM), etc. have a relatively low latency.

As electronic equipment, such as computers, become more complicated and have more functions, semiconductor memory devices used for the electronic equipment are needed to have increased capacity. Therefore, it may be more advantageous to use a memory module where a plurality of semiconductor memory devices is mounted on a printed circuit board (PCB), rather than using separate semiconductor memory devices.

### SUMMARY OF THE INVENTION

Accordingly, the present invention is provided to substantially obviate one or more problems due to limitations and disadvantages of the related art.

Some embodiments of the present invention provide a memory module having a lower latency.

Some embodiments of the present invention provide a memory system that has improved performance by including a memory module having a lower latency in the memory system.

In accordance with a first aspect, the invention is directed to a memory module which includes a plurality of semiconductor memory devices, a plurality of module tabs and a memory buffer. The plurality of the semiconductor memory devices stores first data, wherein at least one of the plurality of the semiconductor memory devices has a lower latency. The plurality of module tabs is used to transfer a signal and data to/from an external device. The memory buffer buffers the first data output from the semiconductor memory devices to the module tabs and buffers second data and a signal provided from an external device through the module tabs to the semiconductor memory devices.

In one embodiment, an internal bus is configured to transmit a signal and data between the memory buffer and the plurality of the module tabs.

According to another aspect, the present invention is directed to a memory system including a plurality of memory modules, a memory controller and a main bus. At least one of the plurality of the memory modules has a lower latency. The main bus is used to transfer a signal and data between the memory controller and the plurality of the memory modules.

According to another aspect, the invention is directed to a computer system including a plurality of memory modules, a memory controller and a processor. At least one of the plurality of the memory modules has a lower latency. The main bus is used to transmit a signal and data between the memory controller and the plurality of the memory modules. The processor controls the memory controller.

### BRIEF DESCRIPTION OF THE DRAWINGS

The foregoing and other objects, features and advantages of the invention will be apparent from the more particular description of preferred aspects of the invention, as illustrated in the accompanying drawings in which like reference characters refer to the same parts throughout the different views. The drawings are not necessarily to scale, emphasis instead being placed upon illustrating the principles of the invention.

FIG. 1 is a schematic view illustrating a memory system according to an example embodiment of the present invention.

FIGS. 2A and 2B are plan views illustrating a memory module having low latency included in the memory system in FIG. 1.

FIGS. 3A and 3B are plan views illustrating a memory module having low latency included in the memory system in FIG. 1 according to another example embodiment of the present invention.

FIG. 4 is a timing diagram illustrating a latency of a memory module during a read operation.

FIG. 5 is a schematic view illustrating a computer system according to an example embodiment of the present invention.

### DESCRIPTION OF THE EMBODIMENTS

Hereinafter, the present invention will be explained in detail with reference to the accompanying drawings.

It will be understood that, although the terms first, second, etc. may be used herein to describe various elements, these elements should not be limited by these terms. These terms are used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

The terminology used herein is for the purpose of describing particular embodiments and is not intended to be limiting of the invention. As used herein, the singular forms “a”, “an” and “the” are intended to include the plural forms as well, unless the context clearly indicates otherwise. It will be further understood that the terms “comprises”, “comprising”, “includes” and/or “including”, when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

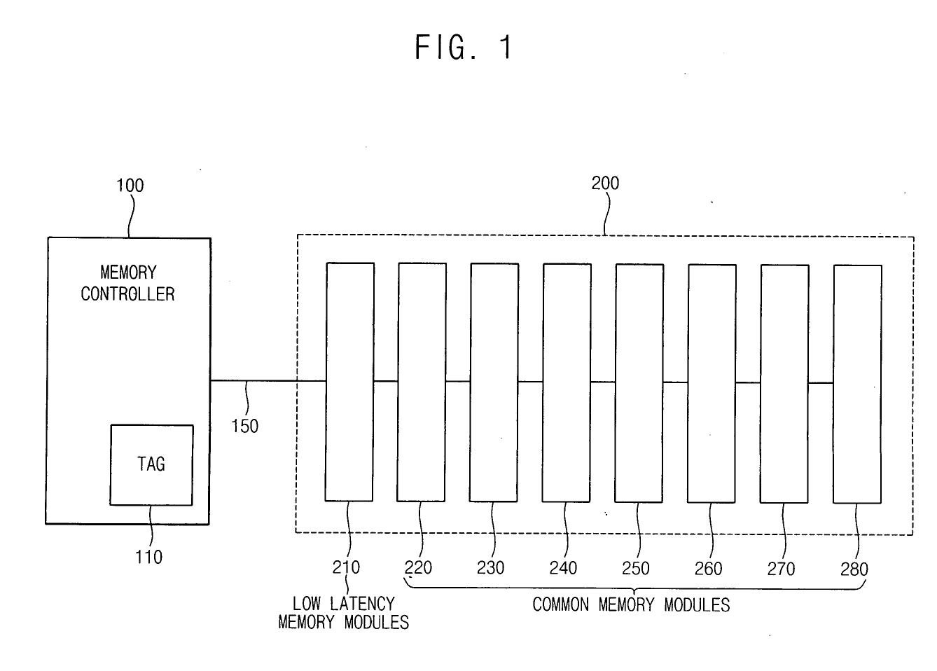

FIG. 1 is a schematic view illustrating a memory system according to an example embodiment of the present invention.

Referring to FIG. 1, the memory system includes a plurality of memory modules 200 and a memory controller 100. The plurality of the memory modules 200 includes a memory module 210 having relatively low latency and common memory modules 220, 230, 240, 250, 260, 270 and 280 having normal latency. Although it is illustrated that the memory system includes only one memory module 210 having low latency and seven common memory modules 220, 230, 240, 250, 260, 270 and 280 in FIG. 1, the number of memory modules having low latency and the number of common memory modules having normal latency of the memory system may vary in different embodiments.

In addition, the memory system includes a main bus 150 through which a signal and data are transmitted between the memory controller 100 and the memory modules 200. The memory controller 100 may include a tag 110. The memory controller 100 controls an operation of the memory modules 200.

The memory controller 100 recognizes memory modules 200 having low latency by using the tag 110 so that the memory modules 200 having low latency may be used as common cache memories. Also, each of the memory modules 210, 220, 230, 240, 250, 260, 270 and 280 may include an advanced memory buffer (AMB) as a memory buffer. The AMB needs to be designed in accordance with a specific protocol that is appropriate for each type of the semiconductor memory device.

For example, when the semiconductor memory device equipped in the memory module is a static random access memory (SRAM), the AMB should support an SRAM protocol and when the semiconductor memory device equipped in the memory module is a dynamic random access memory (DRAM), the AMB should support a DRAM protocol. It is desirable that memory modules having low latency are located close to the memory controller than the common memory module.

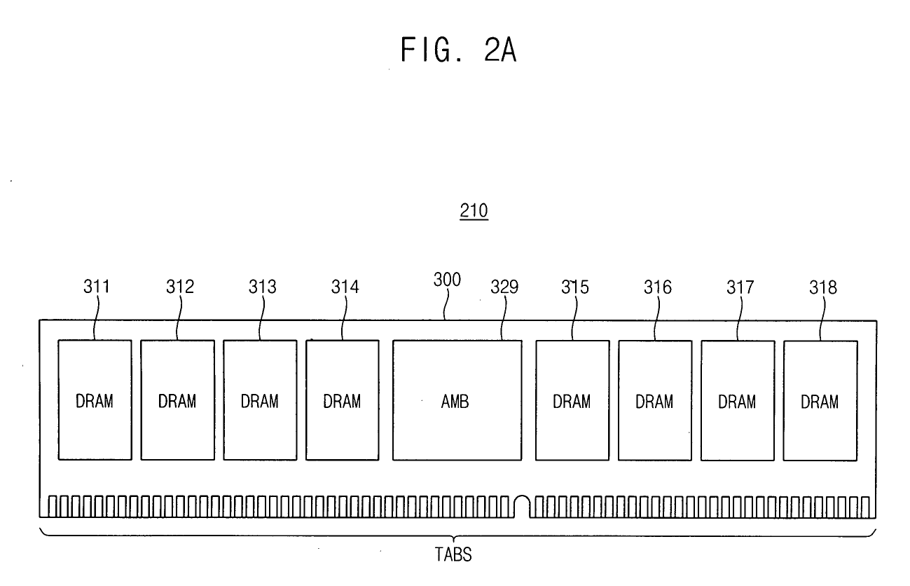

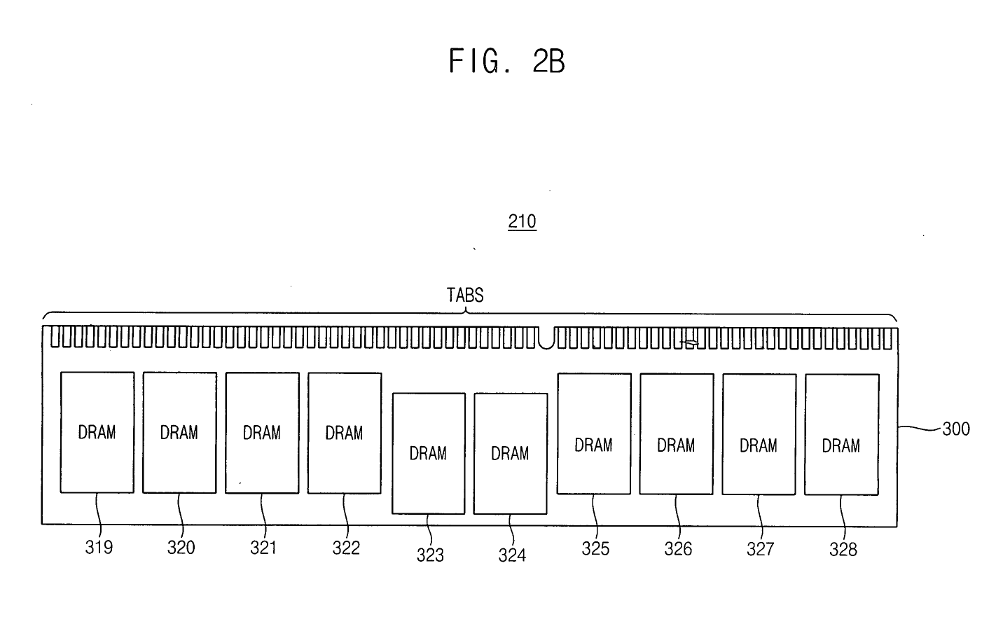

FIGS. 2A and 2B are plan views illustrating the memory module 210 in FIG. 1 having low latency. FIG. 2A illustrates a first side of the memory module 210 having low latency, and FIG. 2B illustrates a second side of the memory module 210. In FIGS. 2A and 2B, internal buses and transmission lines through which signals are transmitted are omitted for the purpose of clarity.

Referring FIGS. 2A and 2B, the memory module 210 having low latency in FIG. 1 may include a printed circuit board (PCB) 300, a plurality of semiconductor memory devices 311 through 328, a plurality of module tabs TABS, and a memory buffer 329. Also, the memory module 210 having low latency includes an internal bus (not shown) for transmitting signals and data between the memory buffer 329 and the plurality of the module tabs TABS. For example, the memory module 210 having low latency in FIGS. 2A and 2B is a Fully Buffered Dual Inline Memory Module (FBDIMM) which uses the advanced memory buffer (AMB) as the memory buffer 329. The AMB is a memory buffer that complies with the Joint Electron Devices Engineering Council (JEDEC) standard which prescribes parallel-to-serial data transformation.

The respective semiconductor memory devices 311 through 328 in FIGS. 2A and 2B include a DRAM having low latency. The plurality of the module tabs TABS is used to transmit signals and data between the memory module 210 and external devices. The memory buffer 329 buffers data outputted from the semiconductor memory devices 311 through 328 to provide the buffered data to the module tabs TABS. The memory buffer 329 also buffers a signal and data inputted from an external device through the module tabs TABS to provide the buffered signal and data to the semiconductor memory devices 311 through 328.

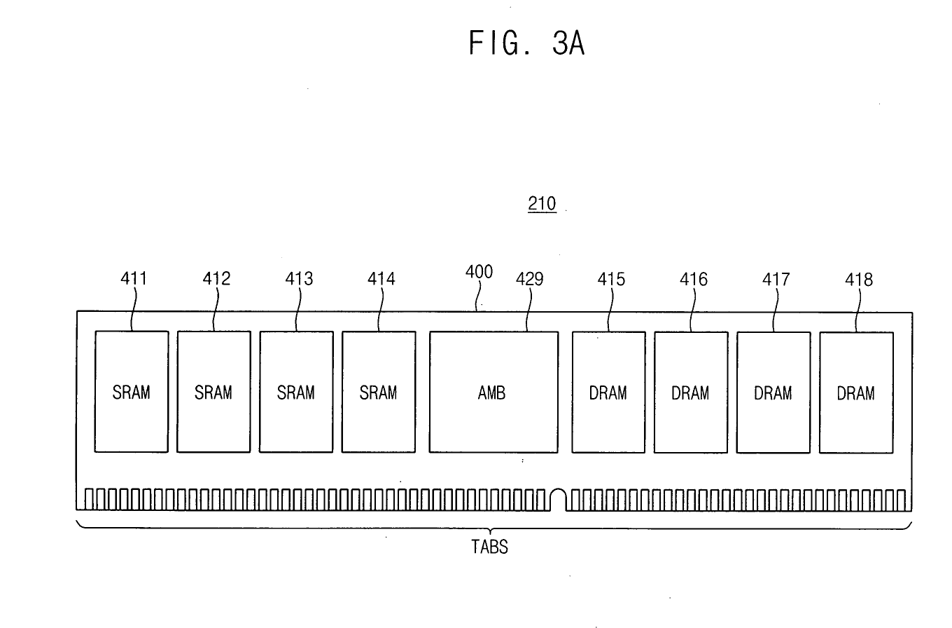

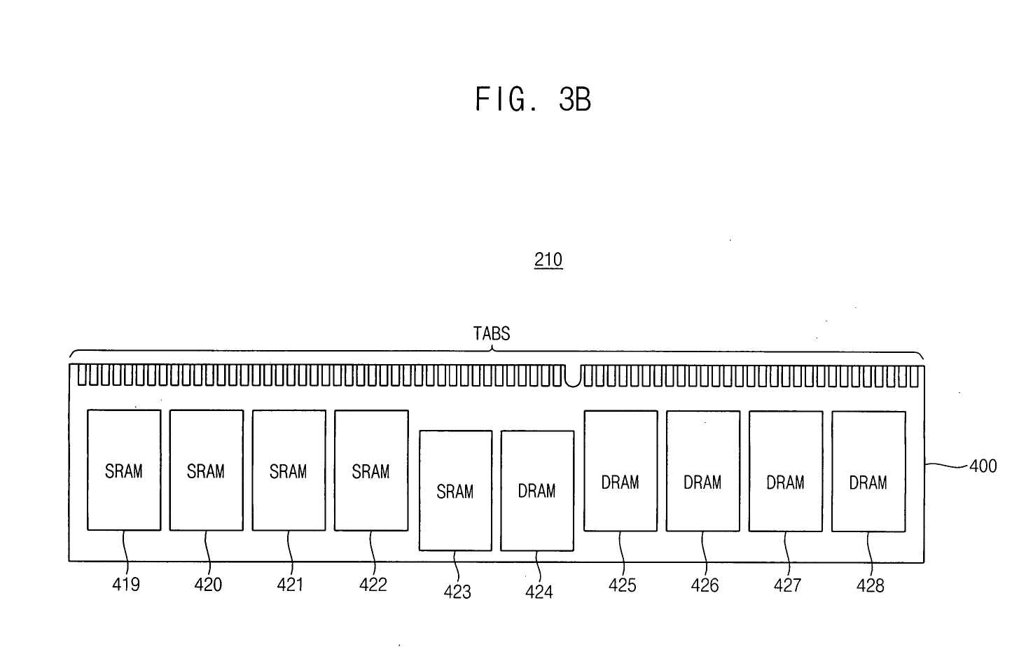

FIGS. 3A and 3B are plan views illustrating the memory module 210 in FIG. 1 having low latency according to another example embodiment of the present invention. FIG. 3A illustrates a first side of memory module 210 having low latency, and FIG. 3B illustrates a second side of the memory module 210. In FIGS. 3A and 3B, internal buses and transmission lines through which signals are transmitted are omitted for the purpose of clarity.

Referring to FIGS. 3A and 3B, the memory module 210 having low latency in FIG. 1 may include a PCB 400, a plurality of semiconductor memory devices 411 through 428, a plurality of module tabs TABS, and a memory buffer 429. Also, the memory module 210 having low latency in FIG. 1 includes an internal bus (not shown) for transmitting signals and data between the memory buffer 429 and the plurality of the module tabs TABS. The memory module 210 having low latency illustrated in FIGS. 2A and 2B is the Fully Buffered Dual Inline Memory Module (FBDIMM), which uses the advanced memory buffer (AMB) as the memory buffer 429. The AMB is a memory buffer that complies with the JEDEC standard.

A portion of the respective semiconductor memory devices 411 to 414, 419 to 423 illustrated in FIGS. 3A and 3B may correspond to the SRAMs having low latency and the remaining semiconductor memory devices 415 to 418, 424 to 428 may correspond to the common DRAMs having normal latency. The SRAMs 411 to 414, 419 to 423 are located in the left side from the center of the PCB 400, and the common DRAM 415 to 418, 424 to 428 having normal latency are located in the right side in FIGS. 3A and 3B. However, it is noted that the SRAMs having low latency and the common DRAMs may constitute the semiconductor memory devices 411 through 428 in any different combination thereof.

The plurality of the module tabs TABS is used to transmit signals between the memory module 210 and an external device. The memory buffer 429 buffers data outputted from the semiconductor memory devices 411 through 428 to provide the buffered data to the module tabs TABS. The memory buffer 429 also buffers a signal and data inputted from an external device through the module tabs TABS and provides the buffered signal and data to the semiconductor memory devices 411 through 428.

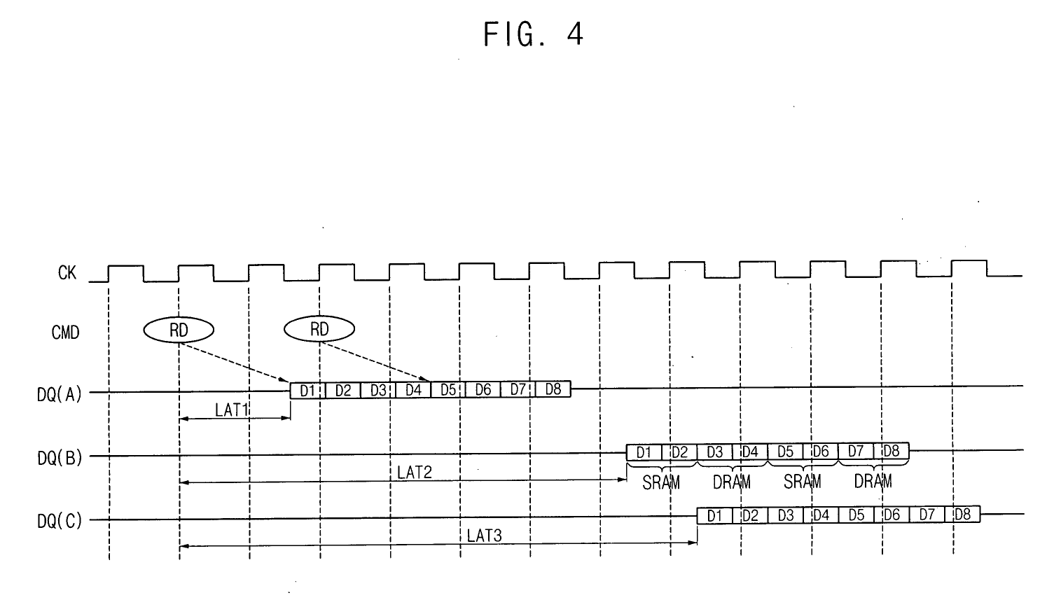

FIG. 4 is a timing diagram illustrating a latency of a memory module during a read operation. In FIG. 4, “CK” denotes a clock, which is used in a memory system and “CMD” denotes a command. “DQ(A)” denotes data outputted from a memory in a case where all of the memory devices in the memory module include DRAMs having low latency. “DQ(B)” denotes data outputted from the memory in a case where one half of the memory devices in the memory module include SRAMs and the remaining one half of the memory devices include DRAMs. In addition, “DQ(C)” denotes data outputted from the memory when all of the memory devices in the memory module include the common DRAMs having normal latency.

The memory system of FIG. 4 operates at a 4-bit burst mode, that is, the memory system outputs four data D1 to D4 or D5 to D8 in response to a read command that is generated every two 2 clock cycles of the clock CK. When all of the memory devices in the memory module include SRAMs, DQ(A) has the latency of LAT1. When one half of the memory devices of the memory module include SRAMs and the remaining half include common DRAMs, DQ(B) has the latency of LAT2. In addition, when all the memory devices in the memory module include the common DRAMs having normal latency, DQ(C) has the latency of LAT3.

Referring to FIG. 4, it can be seen that when one half of the memory devices in the memory module include SRAMs and the remaining half include common DRAMs, data may be outputted approximately one clock cycle earlier than when all of the memory devices include common DRAMs having normal latency. That is, when the clock cycle of clock CK is about 3.8 nanoseconds (ns) and one half of the memory devices in the memory module include SRAMs and the remaining half include common DRAMs, the latency may be reduced by about 3.8 ns compared to that of the memory module that is composed of only DRAMs having normal latency. In addition, when all of the memory devices in the memory module include SRAMs, data may be outputted about six clock cycles earlier than the memory module in which all the memory devices include the common DRAMs.

In a memory system which operates at an 8-bit burst mode, that is, the memory system outputs eight data D1 to D8 in response to a read command, when one half of memory devices in the memory module include SRAMs and the remaining half include common DRAMs, data may be outputted about two clock cycles earlier that the memory module in which all the memory devices include common DRAMs having a common latency.

That is, when the clock cycle of the clock CK is about 3.8 ns, and one half of the memory devices in the memory module include SRAMs and the remaining half include common DRAMs, the latency of the memory module may be reduced about 7.6 ns compared to that when all the memory devices in the memory module include common DRAMs having normal latency.

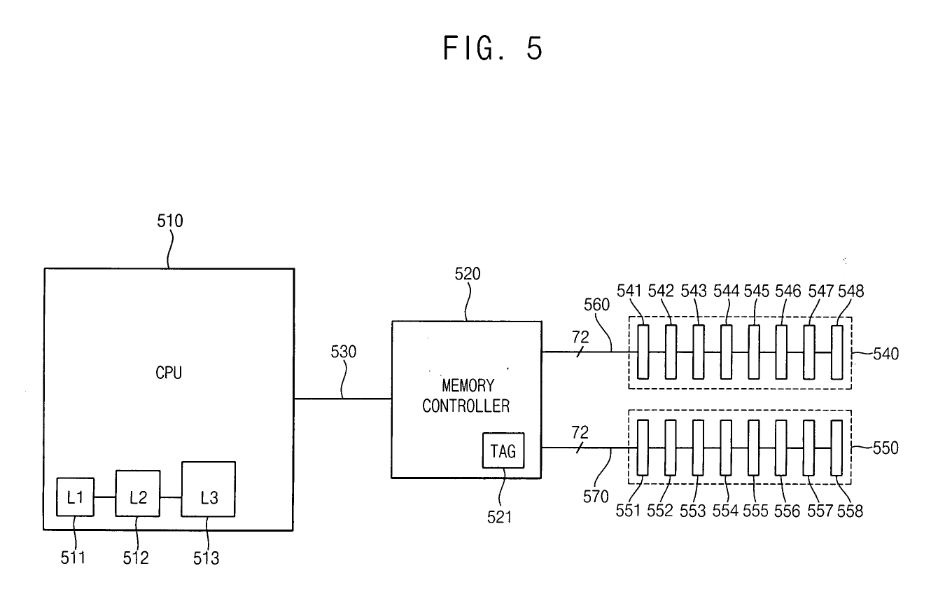

FIG. 5 is a schematic view illustrating a computer system according to an example embodiment of the present invention.

Referring to FIG. 5, the computer system may include a plurality of memory modules 540 and 550, a memory controller 520, a channel 530 and a processor 510. In addition, the computer system may also include main buses 560 and 570 that are used to transmit data and signals between the memory controller 520 and the plurality of the memory modules 540 and 550. In the computer system in FIG. 5, for example, 72 bits of data are transmitted through the main buses 560 and 570 at a time. The plurality of the memory modules 540 includes memory modules 541 through 548 and the plurality of the memory modules 550 includes memory modules 551 through 558.

Each one of the memory modules 540 and 550 includes at least one memory module having low latency. The memory controller 520 controls an operation of the memory modules 541 through 548 and 551 through 558. The main buses are used to transmit signals and data between the memory controller 520 and the plurality of the memory modules 540 and 550. The processor 510 controls the memory controller and performs various signal processors.

The processor 510 may include cache memories L1, L2 and L3. Further, the processor 510 may use the memory module having low latency among the memory modules 541 through 548, 551 through 558 as an additional cache memory.

The memory controller 520 enables the memory module having low latency to be used as a cache memory by using a tag 521, which recognizes the memory module having low latency among the memory modules.

In addition, each of the memory modules 541 through 548 and 551 through 558 includes the AMB as a memory buffer. The AMB needs to be designed in accordance with a specific protocol that is appropriate for each type of the semiconductor memory device. For example, when the semiconductor memory device equipped in the memory module is an SRAM, the AMB should support an SRAM protocol, and when the semiconductor memory device equipped in the memory module is a DRAM, the AMB should support a DRAM protocol.

Although the present invention is discussed herein with reference to a semiconductor memory device such as an SRAM or a DRAM having low latency that constitutes the memory module having low latency, it is noted that any other type of a semiconductor memory device that has low latency may be used to constitute the memory module having low latency.

The memory module and memory system according to an example embodiment of the present invention may include the FBDIMM that serves not only as a cache memory coupled to a processor but also as a direct memory access (DMA) buffer memory. The performance degradation of a computer system is usually due to the time period that is required for a central processing unit (CPU) to fetch data from a hard disk drive (HDD) or a main memory. By reducing the latency (i.e., the time period required to fetch data), the performance of the computer system may be improved. When the memory module having low latency is used for the DMA buffer memory, the latency of the computer system may be reduced.

In order to use the memory module having low latency as the DMA buffer memory, an operating system (OS) should recognize the memory module having low latency. Data that is acquired from an HDD, etc., may be stored in the memory module having low latency to reduce the time period for the central processing unit to access the data. In addition, data that are used frequently in an operation may be stored in the memory module having low latency to increase the speed of the total system.

As described above, in the memory module and the memory system according to the example embodiments of the present invention, the latency time at which data is outputted in response to a read command may be reduced. In addition, the memory module according to the example embodiments of the present invention may be used as a cache memory that is accessed by a processor or a DMA buffer memory.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A memory module comprising:
a plurality of semiconductor memory devices configured to store first data, at least one of the semiconductor memory devices having a lower latency;
a plurality of module tabs through which a signal and data are transferred to/from an external device; and
a memory buffer configured to buffer the first data output from the semiconductor memory devices to the module tabs and configured to buffer second data and a signal provided from an external device through the module tabs to the semiconductor memory devices.

2. The memory module of claim 1, further comprising an internal bus configured to transmit a signal and data between the memory buffer and the plurality of the module tabs.

3. The memory module of claim 1, wherein the memory buffer corresponds to an advanced memory buffer (AMB) that performs serial-to-parallel data transformation on a signal and data provided from an external device.

4. The memory module of claim 3, wherein the AMB is designed in accordance with a protocol for each type of the semiconductor memory device.

5. The memory module of claim 1, wherein the semiconductor memory device having a lower latency corresponds to a dynamic random access memory (DRAM) having a lower latency.

6. The memory module of claim 1, wherein the semiconductor memory device having a lower latency corresponds to a static random access memory (SRAM) having a lower latency.

7. The memory module of claim 1, wherein all of the semiconductor memory devices have a lower latency.

8. A memory system comprising:
a plurality of memory modules, at least one of the memory modules having a lower latency;
a memory controller; and
a main bus configured to transfer a signal and data between the memory controller and the memory modules.

9. The memory system of claim 8, further comprising an internal bus configured to transmit a signal and data between the memory buffer and the module tabs.

10. The memory system of claim 8, wherein each of the memory modules includes:
a plurality of semiconductor memory devices configured to store first data, at least one of the plurality of the semiconductor memory devices having a lower latency;
a plurality of module tabs through which a signal and data are transferred to/from an external device; and
a memory buffer configured to buffer the first data output from the semiconductor memory devices to the module tabs and configured to buffer second data and a signal provided from an external device through the module tabs to the semiconductor memory devices.

11. The memory system of claim 10, wherein the memory module corresponds to an advanced memory buffer (AMB) that performs serial-parallel data transformation on a signal and data provided from an external device.

12. The memory system of claim 10, wherein the semiconductor memory device having a lower latency is an SRAM, or a DRAM having a lower latency.

13. The memory module of claim 10, wherein all of the plurality of the semiconductor memory devices have a lower latency.

14. The memory system of claim 8, wherein the at least one memory module is used as a cache memory.

15. The memory system of claim 8, wherein the at least one memory module is used as a direct memory access (DMA) buffer memory.

16. A computer system comprising:
a plurality of memory modules at least one of which has a lower latency;
a memory controller;
a main bus configured to transmit a signal and data between the memory controller and the memory modules; and
a processor configured to control the memory controller.

17. The computer system of claim 16, wherein each of the memory modules includes:
a plurality of semiconductor memory devices configured to store first data, at least one of the semiconductor memory devices having a lower latency;
a plurality of module tabs through which a signal and data are transmitted to/from an external device;
a memory buffer configured to buffer the first data output from the semiconductor memory devices to the module tabs and configured to buffer second data and a signal provided from an external device through the module tabs to the semiconductor memory devices; and
an internal bus configured to transmit a signal and data between the memory buffer and the plurality of the module tabs.

18. The computer system of claim 17, wherein the memory module corresponds to an advanced memory buffer (AMB) that performs serial-parallel data transformation on a signal and data provided from an external device.

19. The computer system of claim 17, wherein the semiconductor memory device having a lower latency corresponds to one of an SRAM, a network DRAM, and a DRAM having a lower latency.

20. The computer system of claim 17, wherein all of the plurality of the semiconductor memory devices have a lower latency.

21. The computer system of claim 17, wherein the at least one memory module is used as a cache memory.

22. The computer system of claim 17, wherein the at least one memory module is used as a direct memory access (DMA) buffer memory.
